(19) United States
(12) Patent Application Publication
(10) Pub. No.: US 2011/0126425 A1
(43) Pub. Date: Jun. 2, 2011

(54) REMOVABLE PUNCTURE PROTECTIVE FOOTWEAR INSERT

(76) Inventor: Timothy Thomas O'Dowd, Lake Charles, LA (US)

(21) Appl. No.: 12/955,820

(22) Filed: Nov. 29, 2010

Related U.S. Application Data
(60) Provisional application No. 61/264,825, filed on Nov. 29, 2009.

(51) Int. Cl. A43B 13/38; B29C 43/20

(52) U.S. Cl. 36/44; 36/73; 156/245; 156/267

(57) ABSTRACT

The present invention is a removable puncture protective footwear insert with an insole with an orthotic shape that includes an arch support and a heel cup made of a cellular foam product, a multiple layer protective material where the layers are bonded together and held within the insole and a cushioning and shock absorption material that helps maintain the insole orthotic shape. The cellular foam product is Poron or ethylene vinyl acetate, Poron and ethylene acetate and the insole can be with or without the heel cup. The multiple layer protective material is a SWEN FLEX material or Lenz Egisto puncture proof material. There are also two or more separate methods for manufacturing a removable puncture protective footwear insert.

This application claims priority to U.S. Provisional Application 61/264,825 filed on Nov. 29, 2009, the entire disclosure of which is incorporated by reference.

### TECHNICAL FIELD & BACKGROUND

Men, women, children and workers such as residential, commercial, industrial, construction workers that include contractors, brick layers, framers, roofers, siding installers, laborers, supervisors and project manager workers, technicians, law enforcement officers, firemen, demolition workers and cleanup crews that work in hazardous environments, job sites and facilities that are closed off from the public that are not constantly clean and safe from unseen dangers such as nails, screws, metal, and glass, welding rods and other unforeseen threats are exposed to injury to the bottom of their feet. Children are also at risk for the same type of injuries. In the process of playing, walking or running they often are not aware of all the unforeseen dangers that are around them that are serious dangerous threats.

The present invention generally relates to a removable puncture protective footwear insert. More specifically, the invention is a removable puncture protective footwear insert.

It is an object of the invention to provide a removable puncture protective footwear insert to help prevent serious puncture or cut wounds to the sole of a person's foot from stepping on nails, screws, metal, wood and other sharp objects.

It is an object of the invention to provide a removable puncture protective footwear insert that would eliminate the costly effects of the end user having any sharp objects penetrating the soles of their feet and result in pain and suffering, emergency room and doctor fees, x-rays, bloodstream and skin infections, loss of work or school, increase in insurance rates, possible lawsuits, infection and a possible amputation act.

It is an object of the invention to provide a removable puncture protective footwear insert that can be orthotic or non-orthotic.

What is needed is a removable puncture protective footwear insert to help prevent serious puncture or cut wounds to the sole of a person's foot from stepping on nails, screws, metal, wood and other sharp objects, that would eliminate the costly effects of the end user having any sharp objects penetrating the soles of their feet and result in pain and suffering, emergency room and doctor fees, x-rays, bloodstream and skin infections, loss of work or school, increase in insurance rates, possible lawsuits, infection and a possible amputation act and provide a removable puncture protective footwear insert that can be orthotic or non-orthotic.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a side environmental perspective view of a removable puncture protective footwear insert, in accordance with one embodiment of the present invention.

FIG. 1B illustrates an overhead side perspective view of a removable puncture protective footwear insert, in accordance with one embodiment of the present invention.

FIG. 1C illustrates a side perspective view of a removable puncture protective footwear insert, in accordance with one embodiment of the present invention.

FIGS. 2A-2C illustrates a flow chart of a first method for manufacturing a removable puncture protective footwear insert, in accordance with one embodiment of the present invention.

FIGS. 3A-3C illustrates a flow chart of a second method for manufacturing a removable puncture protective footwear insert, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

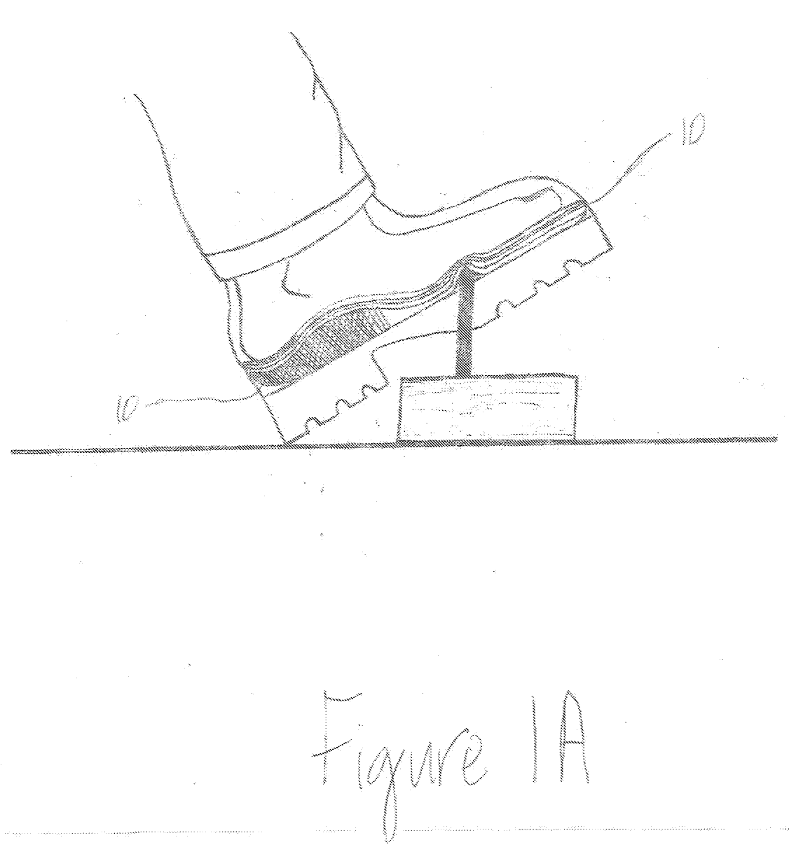

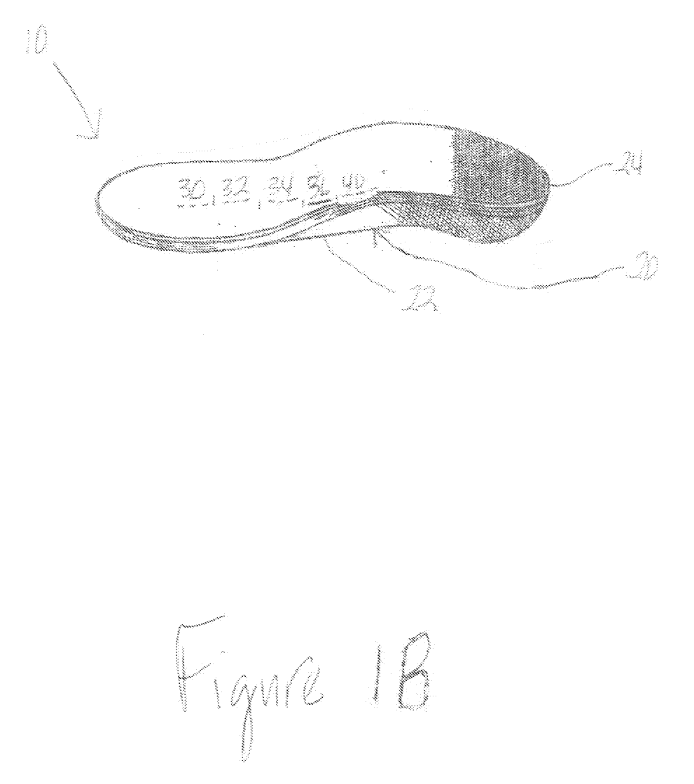

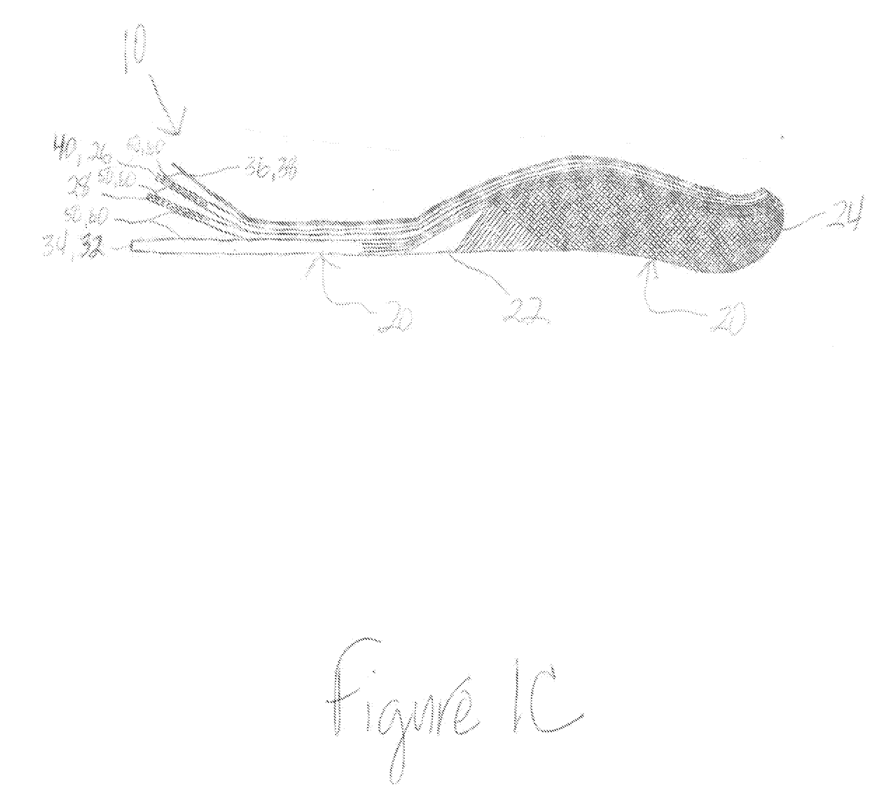

FIG. 1A illustrates a side environmental perspective view of a removable puncture protective footwear insert 10, in accordance with one embodiment of the present invention. The removable puncture protective footwear insert 10 can be worn by men, women, children and workers such as residential, commercial, industrial and construction workers that include contractors, brick layers, framers, roofers, siding installers, laborers, supervisors and project manager workers, technicians, law enforcement officers, firemen, demolition workers and cleanup crews that work in hazardous environments, job sites and facilities that are closed off from the public that are not constantly clean and safe from unseen dangers such as nails, screws, metal, and glass, welding rods and other unforeseen threats are exposed to injury to the bottom of their feet. The removable puncture protective footwear insert 10 can be an orthotic or non-orthotic insert made to help prevent serious puncture and cut wounds to the soles of a person's feet from stepping on nails, screws, metal, wood and other sharp objects. The removable puncture protective footwear insert 10 can be trimmed or shaped to serve as an insert for any type of footwear that covers 100% of the entire sole of a person's foot from that person's toes to that person's heel. The removable puncture protective footwear insert 10 can also be a pre-made insert of various sizes of various types of footwear. The various types of footwear include boots, work boots, sneakers, shoes and other footwear that is well known in the art.

FIG. 1B illustrates an overhead side perspective view of a removable puncture protective footwear insert 10, in accordance with one embodiment of the present invention. FIG. 1C illustrates a side perspective view of a removable puncture protective footwear insert 10, in accordance with one embodiment of the present invention. The first portion of the removable puncture protective footwear insert 10 is an insole 20 that forms an arch support 22 and heel cup 24 that is made of a cellular urethane foam product, such as Poron™ 26 and or ethylene vinyl acetate (EVA) 28. EVA 28 is a cushioned moldable foam and Poron 26 is a cushioned moldable urethane that helps hold the insole 20 to give the removable puncture protective footwear insert 10 an orthotic shape if desired. Different moldable urethanes like EVA 28 are used for different firmnesses for the arch support 22 to make the arch support 22 stiff with 3 firmness settings, low firmness, medium firmness and heavy firmness. All firmness settings are flexible at the insole 20. The insole 20 is comfortable, flexible, light weight, creates a barrier against hot and cold temperatures and is non-conductive unlike other protective insoles that are made with a stainless steel plate or that are constructed with a stainless steel plate incorporated in the sole of the footwear.

The insole 20 also holds a multiple layer protective material 30, such as SWEN FLEX™ material 32 and or Lenzi Egisto material 34 and TC cotton material 36 or cambrelle moisture resistant material 38 that are bonded together. The multiple layer protective material 30, the SWEN FLEX™ material 32 and the Lenzi Egisto material 34 is typically a fabric but can be any type of material that is well known in the art. The Lenzi Egisto material 34 is puncture proof instead of puncture resistant like the SWEN FLEX material 32. The Lenzi Egisto material 34 is non-conductive and has at least three or more layers of fabric, with a double-faced weft, made of relatively high wear resilient polyester fibers coupled together by a thermoplastic film or an adhesive resin. Each of the layers of the material treated by a coating of polyurethane and or acrylic resin is enriched with micronized ceramic materials in the form of silicates, such as aluminum silicate.

Moldable closed cell foams are used to make the SWEN FLEX material 32 and the Lenzi Egisto material 34 to hold the orthotic shape of the removable puncture protective footwear insert 10 with or without the heel cup 24. The moldable closed cell foams can come in different colors, thicknesses and firmnesses that are well known in the art depending on the relative firmness of the arch support 22 and heel cup 24 that is desired by a user. The moldable closed cell foams help distribute the weight of a person's body evenly over the entire area of a person's foot and sole. As previously described, EVA is one of the closed cell foams 28 made from ethylene vinyl acetate and blended copolymers and has a high level of chemical cross linking, resulting in a semi-rigid product with a fine uniform cell structure that is suitable for use in a wide variety of environments and applications. Benefits of EVA and other types of closed cell foams 28 include relatively good impact and vibration absorption, relatively good weather and chemical resistance including splash resistance to oils and fuels, relatively good acoustic and thermal insulation properties, relatively good buoyancy with low water absorption and relatively good suitability for thermo-forming and thermo-molding.

An open cell moldable urethane 40, such as Urethane™ is used as a cushioning and shock absorption material and also helps to maintain the orthotic shape of the removable puncture protective footwear insert 10 when using the SWEN FLEX material 32 and or Lenzi Egisto material 34. Open cell urethanes 40 are available in a wide variety of colors, thicknesses, densities and surface textures to accommodate almost any activity, from everyday use to the rigorous demands of high-impact sports and exercise. If a precise open cell urethane 40 based material doesn't already exist, one can be custom formulated for the needs of a specific manufacturer's physical and aesthetic requirements. Open cell urethanes 40 have a maximum retention of comfort and flexibility and are made without plasticizers, which means the open cell urethane 40 material will not shrink or become brittle and crack with age. Open cell urethanes 40 retain a like-new softness and flexibility, which results in a high degree of impact absorption meaning more shock absorption and less impact to feet and joints. In side-by-side drop weight tests, open cell urethanes 40 outperformed vinyl sponge, neoprene sponge, sponge rubber, Iatex™ foam and other solid viscoelastic material. Open cell urethanes 40 form permeable layers that form a breathable layer to help feet stay dry and cool and draw water vapor and perspiration away. Open cell urethanes 40 also have excellent compression set resistance which enables durable, long-term performance for gasketing, sealing and cushioning. Open cell urethanes 40 also have low-out gassing and non-fogging and contain no plasticizers or residual chemicals to contaminate any device the open cell urethane 40 forms. Open cell urethanes 40 will not become brittle and crumble and they are non-corrosive to metal and are inherently flame retardant without the use of additives. Many of the open cell urethanes 40 meet flammability requirements of UL HBF and MVSS 302. Engineered open cell urethane 40 formulations also offer a wide modulus range—2-90 psi @ 25% deflection—for more design versatility requirements. Open cell urethanes 40 also have good chemical resistance, are easy to fabricate, die-cut cleanly and work with a broad range of adhesives and have a broad range of formulas and thicknesses from 0.012″ to 0.500″ (0.43 mm to 12.7 mm).

A thermoplastic hot melt film adhesive 50 is used to bond the insole 20, the multiple layer protective material 30, the SWEN FLEX material 32, the Lenzi Egisto material 34, the TC cotton material 36 or cambrelle 38 and the open cell urethane 40 is heat activated between 140 to 340 degrees (Fahrenheit). A second adhesive 60 such as Neoprene™, which is sprayed or rolled on and further bonds the insole 20, multiple layer protective material 30, SWEN FLEX material 32, Lenzi Egisto material 34, TC cotton material 36 or cambrelle 38 and the open cell urethane 40 materials together and is heat activated between 140 and 400 degrees (Fahrenheit) depending on what specific previously mentioned materials are used.

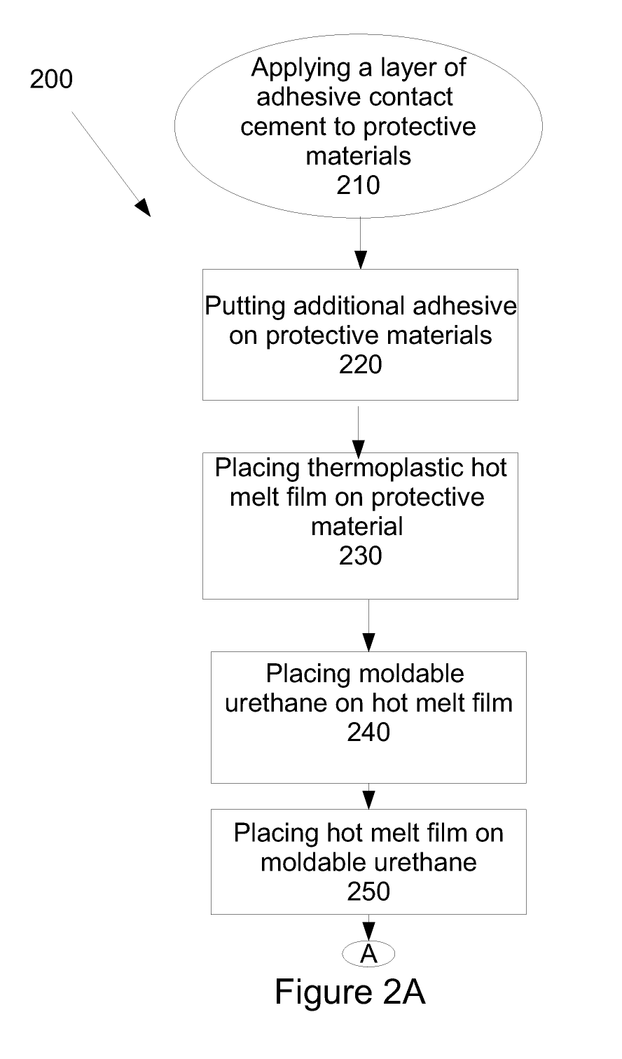

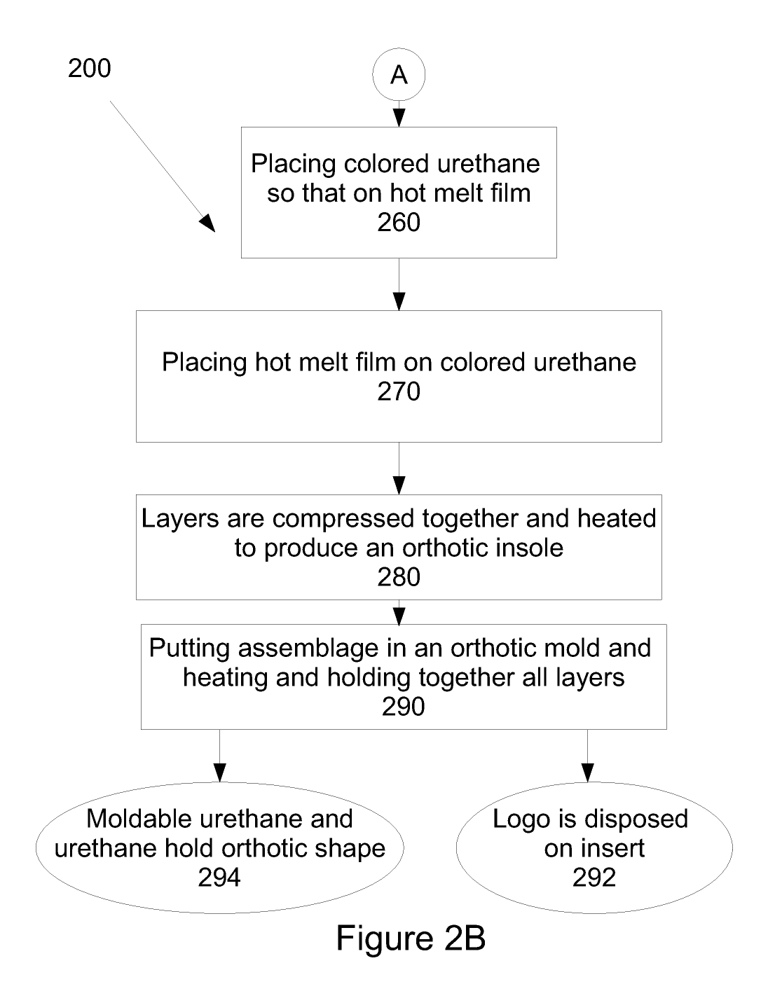

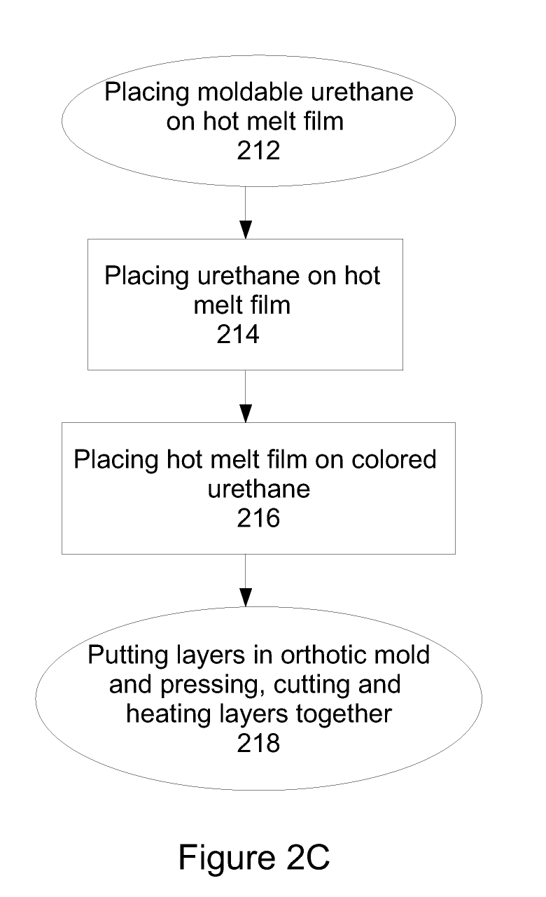

FIGS. 2A-2C illustrate a flow chart of a first method for manufacturing a removable puncture protective footwear insert 200, in accordance with one embodiment of the present invention. The first layer of the removable puncture protective footwear insert 200 is a protective material or fabric. A layer of adhesive contact cement that is specifically chemically formulated to bond open and or closed celled urethanes and or polyurethanes to the protective materials and fabrics is then applied 210. An additional adhesive is put on top of a SWEN-FLEX material, or Lenzi Egisto material or other protective materials or fabrics 220. A layer of thermoplastic hot melt film is then placed on top of the protective material 230 and a layer of moldable urethane is placed on top of the thermoplastic hot melt film 240. A layer of thermoplastic hot melt film is placed on top of the moldable urethane 250 so that a layer of colored urethane is placed on top of the thermoplastic hot melt film 260 which is on top of the moldable urethane. Then a layer of thermoplastic hot melt film is placed on top of the colored urethane 270 so that a layer of materials, fabrics, amarelle or moisture resistant fabric and logo are compressed together and heated to activate the thermoplastic hot melt film which molds and bonds all layers to produce an orthotic removable puncture resistant insole that can be trimmed to fit any footwear 280 forming an assemblage.

Other thicknesses of urethanes can be used to hold the protective material or materials to an orthotic shape, although the thickness of one embodiment of the insole is ¼″. The entire assemblage is then all put in an orthotic mold, then pressed, cut and heated to hold all layers of material or fabrics together 290. Other thicknesses of moldable urethane's or other moldable materials that are well known in the art can be used to hold the protective materials to the orthotic shape. A logo can also be disposed on top of the removable puncture protective footwear insert if desired by a user 292. The moldable urethane and the urethane can also be used to hold the protective material or fabric to the orthotic shape 294.

The moldable urethane can also be placed on top of the thermoplastic hot melt film which is on top of the protective material and then a layer of thermoplastic hot melt film is placed on top of the moldable urethane 212. Then the urethane is placed on top of the thermoplastic hot melt film which is on top of the moldable urethane 214. A layer of thermoplastic hot melt film is placed on top of the sized and colored urethane and then fabric that can be of any color that is well known in the art, is placed on top of the thermoplastic hot melt film which is on top of the sized and colored urethane 216. Other thicknesses of moldable urethane's, other types of urethane or other moldable materials can be used to hold the protective material or fabric to the orthotic shape. It is then all put in an orthotic mold, then pressed, cut and heated to bold all layers of material and fabrics together 218.

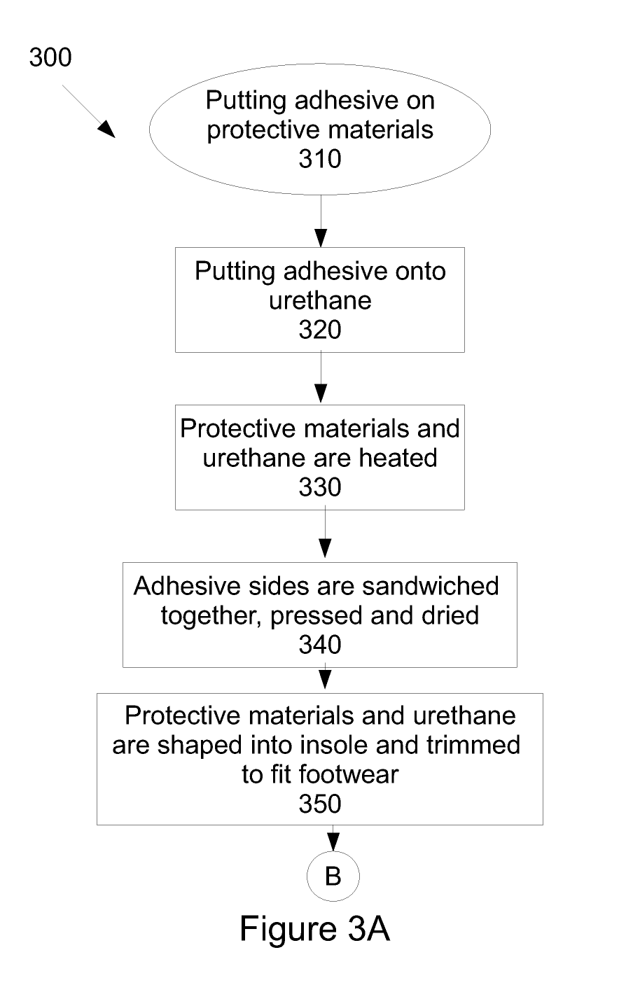

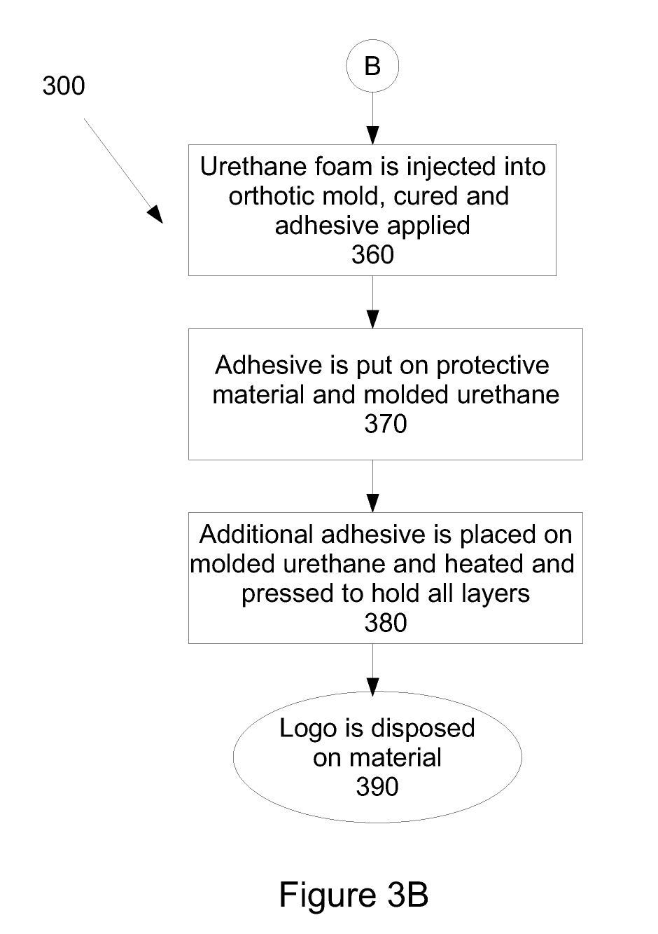

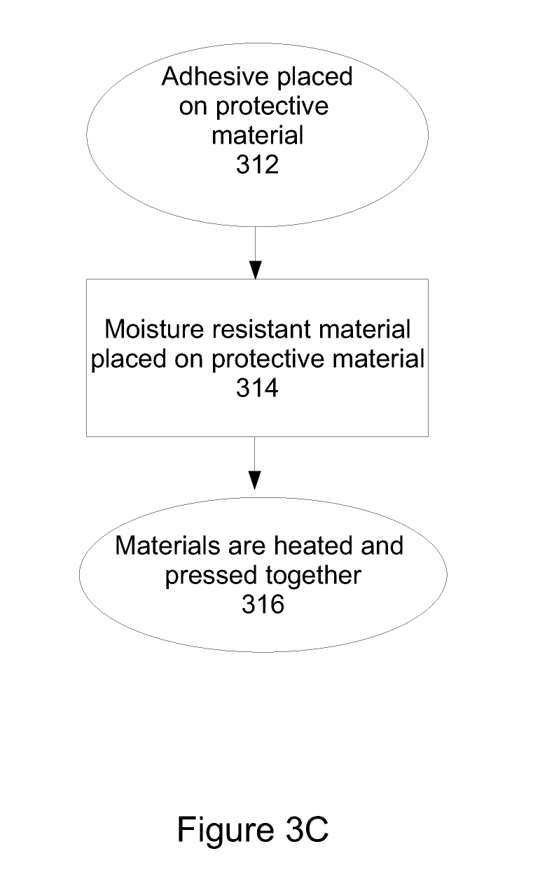

FIGS. 3A-3C illustrates a flow chart of a second method for fitting a removable puncture protective footwear insert 300, in accordance with one embodiment of the present invention. A layer of adhesive is put on top of the protective materials 310 and then the adhesive is put onto a layer of any size and color of urethane 320. The protective materials and urethane are then heated to approximately 400 degrees (F.) 330 where both adhesive sides are then sandwiched together and are then pressed with a roll pin type action and are then dried 340. After drying, the protective materials and urethane will be stamped out into the shape of a flat non-orthotic insole that can be trimmed to fit into any piece of footwear to cover and protect 100% of the user's sole 350. This is an improvement over many stainless steel plated insoles that are well known in the art that only cover and protect 85% of the user's sole. Other thicknesses of moldable urethane's or other moldable materials that are well known in the art can be used to hold the protective material or fabric to the orthotic shape of the insole.

Urethane foam can also be injected into an orthotic mold, cured and taken out and a layer of adhesive is applied on the bottom of the molded urethane foam 360. Adhesive is then put on top of the protective material and the molded urethane is placed on top of the protective material 370 and additional adhesive is placed on top of the molded urethane and moisture resistant material or other types of material heated and pressed to hold all of the layers of material and adhesive together 380. A logo can also be disposed on top of the material 390. Adhesive can also be placed on top of the protective material 312 and a moisture resistant material can be placed on top of the protective material 314 and is heated and pressed together to bond the adhesive and protective material together 316.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A removable puncture protective footwear insert, comprising:
an insole with an orthotic shape that includes an arch support and a heel cup made of a cellular foam product that covers an entire bottom of a user's foot;
a multiple layer protective material wherein said layers are bonded together and held within said insole; and
a cushioning and shock absorption material that helps maintain said insole orthotic shape.

2. The insert according to claim 1, wherein said cellular foam product is Poron or ethylene vinyl acetate.

3. The insert according to dam 1, wherein said cellular foam product is Poron and ethylene vinyl acetate.

4. The insert according to claim 1, wherein said insole is without said heel cup.

5. The insert according to claim 1, wherein said multiple layer protective material is a fabric.

6. The insert according to claim 1, wherein said multiple layer protective material is a SWEN FLEX material or Lenzi Egisto puncture proof material.

7. The insert according to claim 1, wherein said multiple layer protective material is a SWEN FLEX material and Lenzi Egisto material.

8. The insert according to claim 1, wherein a thermoplastic hot melt film adhesive bonds said insole, said SWEN FLEX material, said Lenzi Egisto material, said cambrelle and said cushioning and shock absorption material together.

9. The insert according to claim 1, wherein a second adhesive bonds said insole, said SWEN FLEX material, said Lenzi Egisto material, said TO cotton material or cambrelle and said cushioning and shock absorption material.

10. The insert according to claim 9, wherein said second adhesive is heat activated.

11. The insert according to claim 10, wherein said second adhesive is heat activated between 140 and 400 degrees Fahrenheit.

12. The insert according to claim 1, wherein said cushioning and shock absorption material is an open cell urethane.

13. A first method for manufacturing a removable puncture protective footwear insert, comprising the steps of:
applying a layer of adhesive contact cement that is formulated to bond open or closed celled urethanes or polyurethanes to a plurality of protective materials and fabrics;
putting an additional adhesive on top of a SWEN-FLEX material or a Lenzi Egisto material or other said protective materials or fabrics;
placing a layer of a thermoplastic hot melt film on top of said protective material or fabrics and placing a layer of moldable urethane on top of said thermoplastic hot melt film;
placing said layer of thermoplastic hot melt film on top of said moldable urethane and placing a layer of colored urethane on top of said thermoplastic hot melt film, which is on top of said moldable urethane;
placing a layer of said thermoplastic hot melt film on top of said layer of colored urethane so that said layers are compressed together and heated to activate said thermoplastic hot melt film which molds and bonds all said layers;
producing an orthotic removable puncture resistant insole that can be trimmed to fit any footwear forming an assemblage; and
putting said assemblage in an orthotic mold and pressing, cutting, heating and holding all said layers together.

14. The method according to claim 13, wherein a logo can be disposed on top of said removable puncture protective footwear insert if desired by a user.

15. The method according to claim 13, wherein said moldable urethane and said urethane can be used to hold said protective material or fabric into said orthotic shape.

16. The method according to claim 13, wherein sad moldable urethane can be placed on top of said thermoplastic hot melt film which is on top of said protective material, said layer of thermoplastic hot melt film is placed on top of said moldable urethane, said urethane is placed on top of said thermoplastic hot melt film which is on top of said moldable urethane, a layer of said thermoplastic hot melt film is placed on top of said sized and colored urethane and a fabric of any color is placed on top of said thermoplastic hot melt film on top of said sized and colored urethane and all said layers are put in an orthotic mold and are pressed, cut and heated to hold all said layers together.

17. A second method for manufacturing a removable puncture protective footwear insert, comprising the steps of:
putting a layer of adhesive on top of a plurality of protective materials;
putting said adhesive onto a layer of urethane;
heating said protective materials and urethane to approximately 400 degrees Fahrenheit;
drying and sandwiching both said adhesive sides together; and
stamping out and shaping said protective materials and urethane of a flat non-orthotic insole that can be trimmed to fit into any piece of footwear to cover and protect 100% of a user's sole.

18. The method according to claim 17, wherein said urethane foam can be injected into an orthotic mold, cured and taken out and a layer of said adhesive is applied on a bottom of said molded urethane foam, said adhesive is put on top of said protective material and said molded urethane is placed on top of said protective material, additional adhesive is placed on top of said molded urethane and moisture resistant material is heated and pressed to hold all of said layers of material and adhesive together.

19. The method according to claim 18, wherein a logo is disposed on top of said layers of material.

20. The method according to claim 17, wherein said adhesive can be placed on top of said protective material and a moisture resistant material can be placed on top of said protective material and is heated and pressed together to bond said adhesive and protective material together.
